(19) United States
(12) Patent Application Publication
(10) Pub. No.: US 2011/0220262 A1
(43) Pub. Date: Sep. 15, 2011

(54) TIRE CHAINS

(76) Inventor: Wayne Winton, Fruita, CO (US)

(21) Appl. No.: 12/720,589

(22) Filed: Mar. 9, 2010

(51) Int. Cl. B60C 27/20

(52) U.S. Cl. 152/228

(57) ABSTRACT

A customizable tire chain including U-shaped members, grouser bars, and connecting segments. The U-shaped members each have a first leg, second leg, and transverse portion that extends between the first and second legs. The first and second legs are positioned to receive an outer edge portion of a tire therebetween. The connecting segments may connect the first legs, second legs, or transverse portions of the U-shaped members together. A first side of each of the grouser bars includes a traction structure. The second side of each of the grouser bars is removably coupled to the transverse portion of a corresponding one of the U-shaped members. In some embodiments, first and second ends of the grouser bars each extend laterally beyond the transverse portion of the corresponding U-shaped member. In such embodiments, the grouser bars may be coupled together at their first and second ends by the connecting segments.

### BACKGROUND OF THE INVENTION

1. Field of the Invention

The present invention is directed generally to tire chains.

2. Description of the Related Art

A tire chain is used to improve traction between a tire and a driving surface. Tire chains are typically used when the driving surface includes mud or loose dirt or is covered by snow and/or ice. Unfortunately, many conventional tire chain designs are difficult to install and require constant monitoring and/or retightening to function properly. Further, many conventional tire chains provide only a small amount of added traction between the tire and the driving surface. Therefore, a need exists for new tire chain designs. A tire chain that requires less retightening or avoids retightening altogether would be particularly desirable. Further, a tire chain that provides an adequate amount of traction between the tire and the driving surface to avoid the tire becoming stuck in mud, loose dirt, and/or snow or sliding on icy roads would also be desirable. The present application provides these and other advantages as will be apparent from the following detailed description and accompanying figures.

### BRIEF DESCRIPTION OF THE SEVERAL VIEWS OF THE DRAWING(S)

FIG. 1 is a perspective view of an exemplary embodiment of a tire chain installed on a conventional tire.

FIG. 2 is a perspective view of a vehicle having six conventional tires depicted with a tire chain like the tire chain of FIG. 1 installed on each the vehicle's front and rear wheels.

FIG. 3 is a top view of the tire chain of FIG. 1 installed on a conventional tire.

FIG. 4 is a perspective view of an underside of a U-shaped member and connecting segments of the tire chain of FIG. 1.

FIG. 5 is a perspective view of an alternate embodiment of a U-shaped member illustrated without traction structures that may be used to construct the tire chain of FIG. 1.

FIG. 6 is a perspective view of an alternate embodiment of a U-shaped member including a traction structure implemented as a single cleat that may be used to construct the tire chain of FIG. 1.

FIG. 7 is a perspective view of an alternate embodiment of a U-shaped member including a traction structure implemented as a single cleat that may be used to construct the tire chain of FIG. 1.

FIG. 8 is a perspective view of two alternate embodiments of U-shaped members that may be used to construct the tire chain of FIG. 1.

FIG. 9 is a perspective view of an alternate embodiment of a U-shaped member including plural traction structures implemented as studs that may be used to construct the tire chain of FIG. 1.

FIG. 10 is a perspective view of an alternate embodiment of a U-shaped member including a traction structure implemented as a segment of V-bar cross-chain that may be used to construct the tire chain of FIG. 1.

FIG. 11 is a partially exploded perspective view of the U-shaped member of FIG. 4 and a grouser bar with a traction structure implemented as a cleat that may be used to construct the tire chain of FIG. 1.

FIG. 12 is a perspective view of the U-shaped member and grouser bar of FIG. 11.

FIG. 13 is a perspective view of the U-shaped member of FIG. 4 and a grouser bar with plural traction structures that may be used to construct the tire chain of FIG. 1.

FIG. 14 is a perspective view of the U-shaped member of FIG. 4 and a U-shaped grouser bar that may be used to construct the tire chain of FIG. 1.

FIG. 15 is a perspective view of the U-shaped member of FIG. 4 and an L-shaped grouser bar that may be used to construct the tire chain of FIG. 1.

FIG. 16 is an exploded perspective view an embodiment of a tire chain in which the connecting segments have been implemented as roller chains.

FIG. 17 is a perspective view of the tire chain of FIG. 16.

FIG. 18 is an exploded perspective view an alternate embodiment of a tire chain having chain segments coupled between adjacent U-shaped members.

FIG. 19 is a perspective view of the tire chain of FIG. 18.

FIG. 20 is an exploded perspective view an embodiment of a tire chain in which the connecting segments have been implemented as cables.

FIG. 21 is a perspective view of the tire chain of FIG. 20.

### DETAILED DESCRIPTION OF THE INVENTION

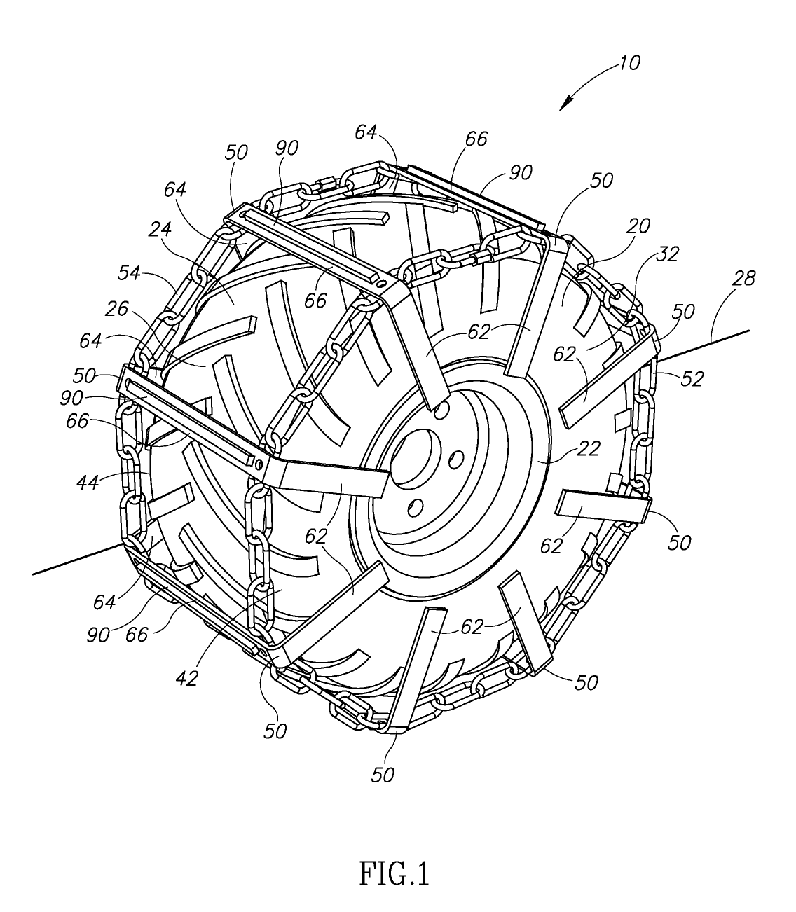

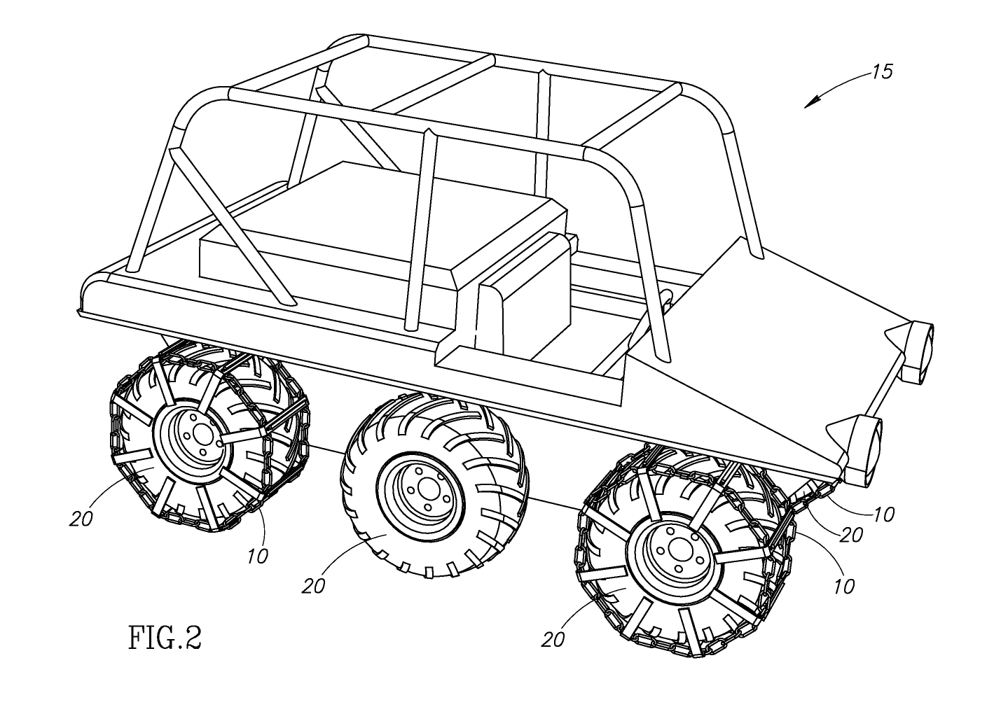

FIG. 1 is an illustration of an embodiment of a tire traction device or tire chain 10 installed on a conventional tire 20 mounted on a conventional rim 22 for rotation therewith. FIG. 2 illustrates a vehicle 15 upon which the tire 20 and the tire chain 10 have been mounted. While the vehicle 15 has been illustrated as an all terrain vehicle (“ATV”) having six conventional tires like the tire 20, the tire chain 10 may be used with tires mounted on other types of vehicles including, without limitation, an ATV having fewer tires (e.g., four tires), an automobile, a truck, a van, a sport utility vehicle (“SUV”), a semi-tractor, heavy equipment, heavy construction equipment, forestry service equipment, agricultural tractors, and the like. The tire chain 10 may be configured for use with any conventional rubber tire used on any type of vehicle.

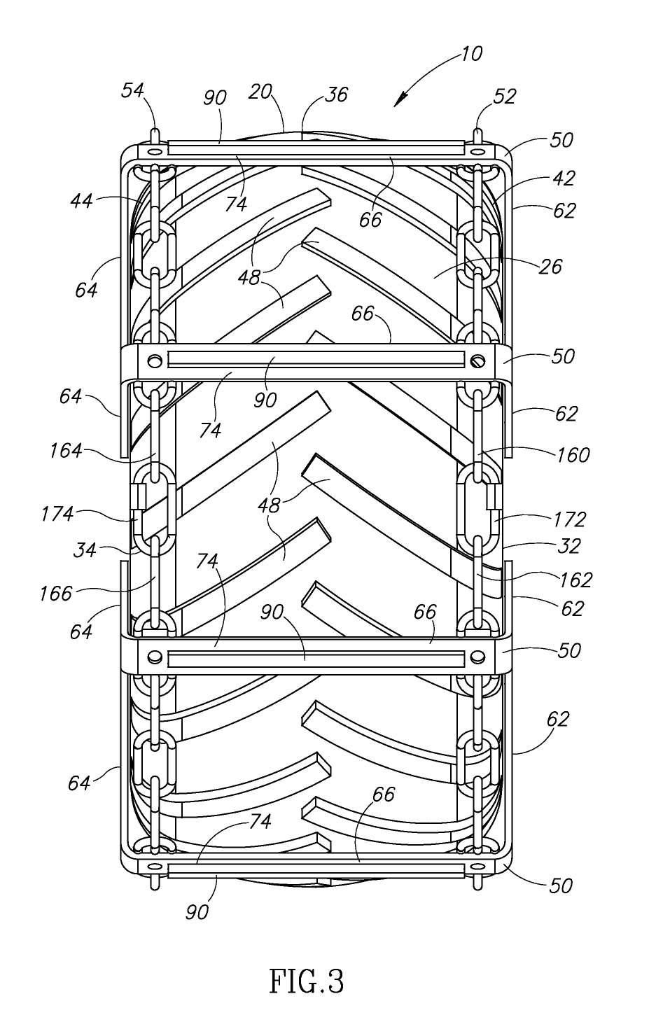

Returning to FIG. 1, the tire 20 is generally annular or ring-shaped having an outer circumferential portion 24 with a curved outwardly facing surface 26 configured to contact the ground 28 as the tire 20 rotates. A first sidewall 32 extends between the outwardly facing surface 26 and the rim 22 and a second sidewall 34 (see FIG. 3) extends between the outwardly facing surface 26 and the rim 22.

As may best be viewed in FIG. 3, the outwardly facing surface 26 has a center portion 36 positioned between opposing side portions 42 and 44. Optionally, treads 48 may be formed on the outwardly facing surface 26. The first side portion 42 is positioned along the intersection of the outwardly facing surface 26 and the first sidewall 32. The second side portion 44 is positioned along the intersection of the outwardly facing surface 26 and the second sidewall 34. In the embodiment illustrated, the outwardly facing surface 26 has a generally convex shape that positions the center portion 36 radially outwardly farther than the opposing side portions 42 and 44.

In the embodiment illustrated in FIGS. 1 and 3, the tire chain 10 includes a plurality of spaced apart U-shaped members 50 connected together serially along the outwardly facing surface 26 of the tire 20 by a pair of spaced apart connecting segments 52 and 54. Further, in the embodiment illustrated in FIGS. 1 and 3, the tire chain 10 is not connected to any portion of the rim 22 and does not pass through any portion of the rim 22. Instead, the tire chain 10 held on the outer circumferential portion 24 of the tire 20 by the shape of the U-shaped members 50 and tension in the connecting segments 52 and 54. However, through application of ordinary skill in the art to the present teachings, the tire chain 10 could be modified to include segments that connect to the rim 22 or pass through a portion of the rim. As the tire 20 is rotated by the vehicle 15 (see FIG. 2), the U-shaped members 50 serial engage the ground 28.

### U-Shaped Members

The U-shaped members 50 are configured such that the connecting segments 52 and 54 are coupled to the U-shaped members 50 at a position adjacent to the side portions 42 and 44, respectively, of the outwardly facing surface 26 of the tire 20. The connecting segments 52 and 54 are further positioned to prevent them from contacting either the ground 28 or the tire 20.

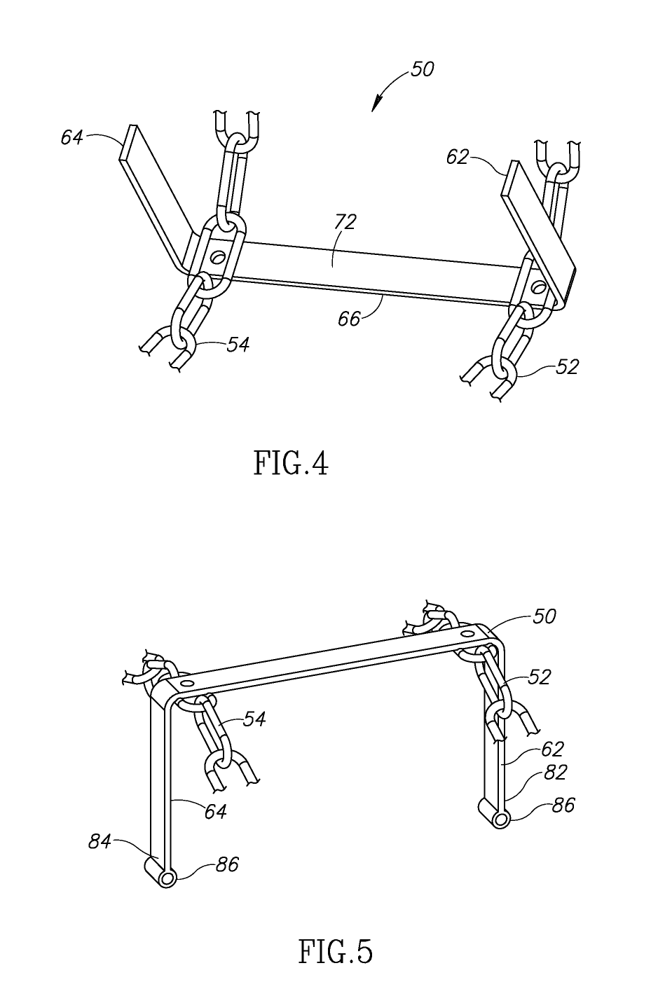

Turning to FIG. 4, each of the U-shaped members 50 has a first leg 62 opposing a second leg 64. Returning to FIGS. 1 and 3, the first and second legs 62 and 64 are connected together by a transverse portion 66. The first and second legs 62 and 64 and the transverse portion 66 may be shaped to match the cross-sectional shape of the outer circumferential portion 24 of the tire 20. However, this is not a requirement.

When the tire chain 10 is installed on the tire 20, the tire 20 is received between the first leg 62 and the second leg 64 to thereby position the transverse portion 66 adjacent the outwardly facing surface 26, the first leg 62 along the first sidewall 32 of the tire 20, and the second leg 64 along the second sidewall 34 of the tire 20. The first and second legs 62 and 64 limit lateral movement of the tire chain 10 relative to the tire 20. Referring to FIG. 3, the transverse portion 66 has an inwardly facing surface 72 (see FIG. 4) that faces the outwardly facing surface 26 of the tire 20 and an outwardly facing surface 74 opposite the inwardly facing surface 72.

In an alternate embodiment illustrated in FIG. 5, the first leg 62 has a distal end portion 82 and the second leg 64 has a distal end portion 84. A connector 86 is connected to each of the distal end portions 82 and 84 of the first and second legs 62 and 64, respectively. Optionally, when assembled to construct the tire chain 10, the connectors 86 of the first legs 62 of the U-shaped members 50 may be connected together by at least one tie (not shown), such as a cable, chain, cord, and the like. Similarly, the connectors 86 of the second legs 64 of the U-shaped members 50 may be connected together by at least one tie (not shown), such as a cable, chain, cord, and the like. However, depending upon the implementation details, connecting the distal end portions 82 and 84 of the U-shaped members 50 in this manner could cause the U-shaped members 50 to be improperly oriented relative to the ground 28 (see FIG. 1) and/or the tire 20 (see FIG. 1) as the tire rotates. Therefore, it may be desirable to leave the distal end portions 82 and 84 of the first and second legs 62 and 64, respectively, untethered to thereby allow the U-shaped members 50 to rotate into position for contact with the ground 28 (see FIG. 1) as the tire 20 rotates.

Referring to FIGS. 1 and 3, the U-shaped members 50 are configured remain in position along the outer circumferential portion 24 of the tire 20 even when lateral side-loading occurs. Lateral side-loading may occur when the vehicle 15 (see FIG. 2) turns and/or slides sideways. Through application of ordinary skill in the art to the present teachings, the U-shaped members 50 are scalable for use with tires of many sizes and weight levels.

As is apparent to those of ordinary skill in the art, the outwardly facing surface 26 of the outer circumferential portion 24 of the tire 20 is exposed between the U-shaped members 50. Therefore, none of the components of the tire chain 10 rubs against the outwardly facing surface 26. Further, portions of the outwardly facing surface 26 between the U-shaped members 50 may contact the ground without any portions of the tire chain 10 being positioned therebetween. While the inwardly facing surfaces 72 (see FIG. 4) of the transverse portions 66 of the U-shaped members 50 each abut a portion of the outwardly facing surface 26 of the tire 20, the inwardly facing surfaces 72 are substantially planar thereby limiting wear of the tire 20 caused by the tire chain 10.

### Traction Structures

Returning to FIG. 3, the outwardly facing surfaces 74 of the transverse portions 66 of the U-shaped members 50 include structures configured to provide traction (“traction structures”) positioned to serially engage the ground 28 (see FIG. 1) as the tire chain 10 is rotated by the tire 20. In the embodiment illustrated in FIG. 3, the traction structures include outwardly extending cleats 90 configured to dig into the ground 28 (see FIG. 1) and/or material disposed on the ground, such as snow, ice, and the like. The cleats 90 extend along the outwardly facing surfaces 74 in a direction that is substantially orthogonal to the direction in which the tire 20 rotates. Thus, the cleats 90 are arranged to be substantially orthogonal to the direction of travel of the vehicle 15 (see FIG. 2). In the embodiment illustrated in FIGS. 1 and 3, each of the cleats 90 is non-removably or permanently affixed (e.g., welded) to one of the U-shaped members 50 and configured to improve traction between the tire 20 and the ground 28 (see FIG. 1).

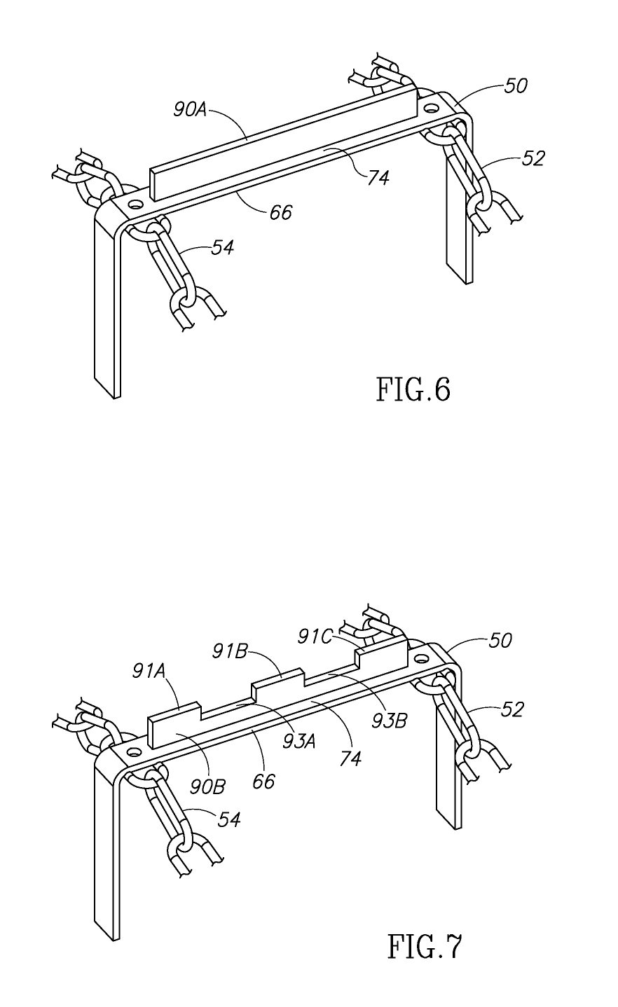

The height of the cleats 90 (i.e., distance the cleats 90 extend outwardly from the outwardly facing surfaces 74 of the transverse portions 66) may be selected based at least in part on the surface conditions of the ground 28 (see FIG. 1). For example, FIG. 6 illustrates a taller cleat 90A for use with the U-shaped members 50 than the cleats 90 illustrated in FIGS. 1 and 3. By way of a non-limiting example, the cleats 90 illustrated in FIGS. 1 and 3 may have a height of about 0.5 inches and the cleat 90A illustrated in FIG. 6 may have a height of about one inch. The cleat 90 illustrated in FIGS. 1 and 3 may be useful for muddy or snowy driving surface. The cleat 90A illustrated in FIG. 6 may be useful in deeper mud and snow.

As is appreciated by those of ordinary skill in the art, the length of the cleat 90 determines at least in part a smoothness of the ride in the vehicle 15 (see FIG. 2) as well as an amount of traction provided by the tire chain 10. A longer cleat is likely provide more traction than a shorter cleat but will also provide a rougher ride than a shorter cleat. Thus, the length of the cleat 90 may be selected at least in part based on a desired ride comfort and a desired amount of traction.

FIG. 7 illustrates a cleat 90B having outwardly extending projecting portions 91A, 91B, and 91C configured to dig into the ground 28 (see FIG. 1) and/or material disposed on the ground, such as snow, ice, and the like. In the embodiment illustrated, the outwardly extending projecting portions 91A and 91B are separated from one another by an intermediate portion 93A and the outwardly extending projecting portions 91B and 91C are separated from one another by an intermediate portion 93B. By way of a non-limiting example, the intermediate portions 93A and 93B may each extend upwardly about 0.5 inches from the outwardly facing surfaces 74 of the transverse portions 66 of the U-shaped members 50 and the projecting portions 91A, 91B, and 91C may each extend upwardly about 0.5 inches beyond the intermediate portions 93A and 93B. By way of another non-limiting example, the intermediate portions 93A and 93B may each extend upwardly about 0.25 inches from the outwardly facing surfaces 74 of the transverse portions 66 of the U-shaped members 50 and the projecting portions 91A, 91B, and 91C may each extend upwardly about 0.25 inches beyond the intermediate portions 93A and 93B. The cleat 90B may be useful on icy surfaces.

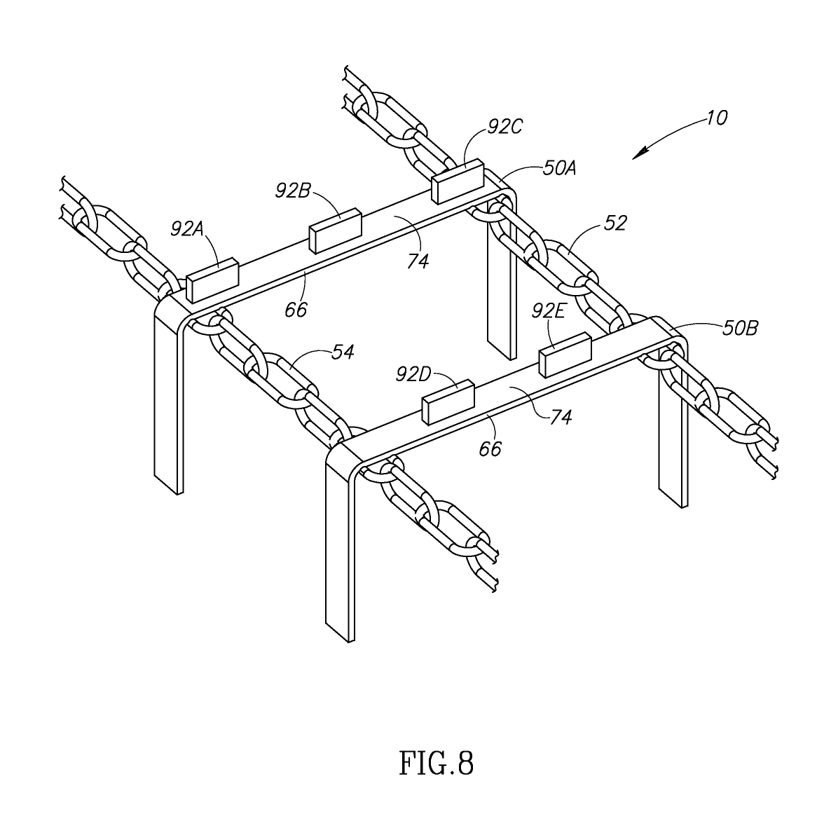

In alternate embodiments, such as the one illustrated in FIG. 8, the traction structures include multiple cleats (e.g., cleats 92A, 92B, and 92C) non-removably affixed to at least a portion of the U-shaped members 50 (e.g., U-shaped members 50A and 50B). Further, the outwardly facing surfaces 74 of the transverse portions 66 of the U-shaped members 50 need not all include the same traction structures. For example, in FIG. 8, the first U-shaped member 50A includes the three spaced apart cleats 92A, 92B, and 92C and the second U-shaped member 50B includes a pair of spaced apart cleats 92D and 92E. The tire chain 10 may include a plurality of first U-shaped members 50A arranged in an alternating fashion with a plurality of second U-shaped members 50B along the connecting segments 52 and 54. This configuration may be useful on icy surfaces.

Depending upon the implementation details, the cleats 92A, 92B, and 92C may extend upwardly about 0.25 inches to about one inch from the outwardly facing surfaces 74 of the transverse portions 66 of the U-shaped members 50A and the cleats 92D and 92E may extend upwardly about 0.25 inches to about one inch from the outwardly facing surfaces 74 of the transverse portions 66 of the U-shaped members 50B.

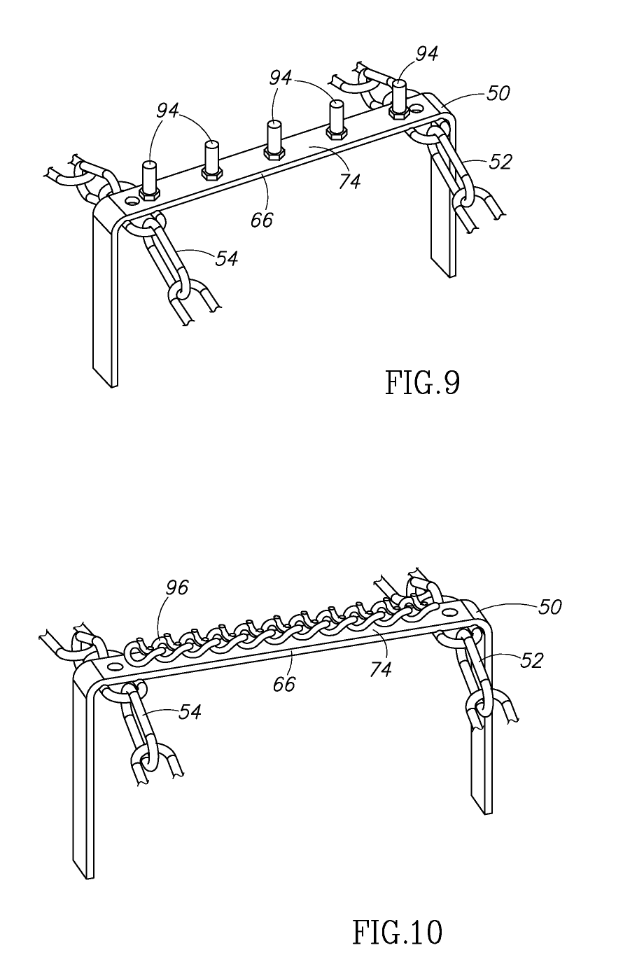

By way of other non-limiting examples, other traction structures, such as outwardly extending studs 94 (see FIG. 9), a section of conventional traction chain 96 (see FIG. 10) used to construct conventional tire chains, and the like, may be non-removably affixed to the outwardly facing surface 74 of the transverse portion 66 the U-shaped member 50. Referring to FIG. 9, by way of a non-limiting example, the studs 94 may be implemented using half inch grade 8 bolts. Referring to FIG. 9, by way of a non-limiting example, the section of conventional traction chain 96 may be implemented using V-bar cross-chain.

A crawler is a vehicle equipped with tracks or treads, like a bulldozer. Each track is typically entwined around and rotated by two or more spaced apart wheels, at least one of which is driven by a drive assembly. Grousers are a type of cleat affixed to a track to improve traction between the track and the ground. Each of the U-shaped members 50 illustrated in drawings is configured to function in a manner similar to that of a grouser. However, referring to FIG. 1, instead of being mounted on a track, the U-shaped members 50 are connected to the connecting segments 52 and 54.

### Grouser Bars

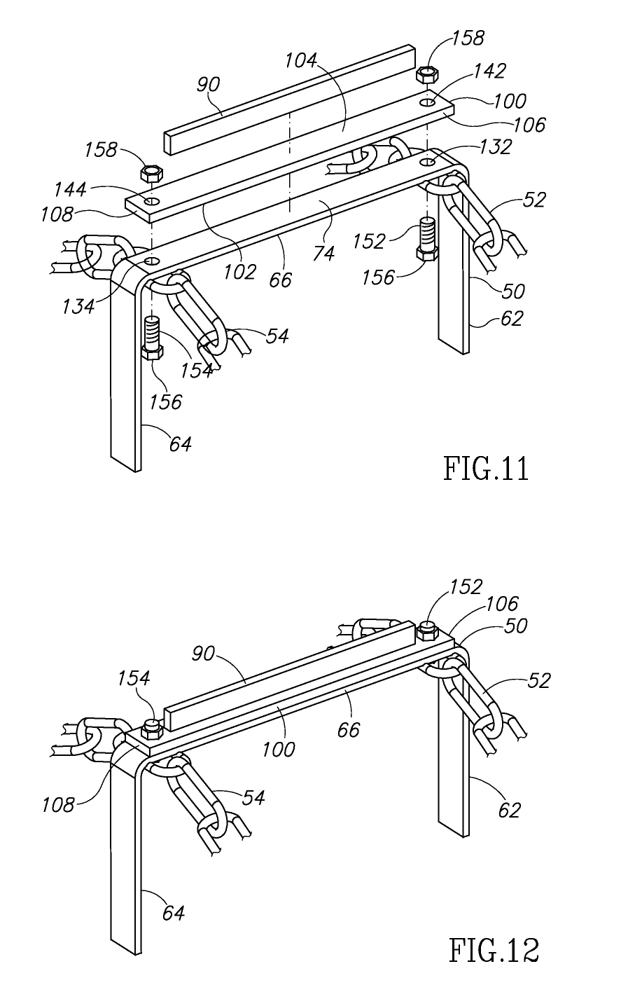

Referring to FIGS. 11 and 12, in particular embodiments, instead of affixing (e.g., welding) one or more traction structures (e.g., the cleat 90) directly to the U-shaped member 50, the traction structures are permanently affixed to a grouser bar 100 that is removably coupled to the outwardly facing surface 74 (see FIG. 11) of the transverse portion 66 of the U-shaped member 50. The grouser bar 100 has a first surface 102 configured to be adjacent the outwardly facing surface 74 of the transverse portion 66 of the U-shaped members 50 and a second outwardly facing surface 104 opposite the first surface 102. The grouser bar 100 has a first end portion 106 opposite a second end portion 108.

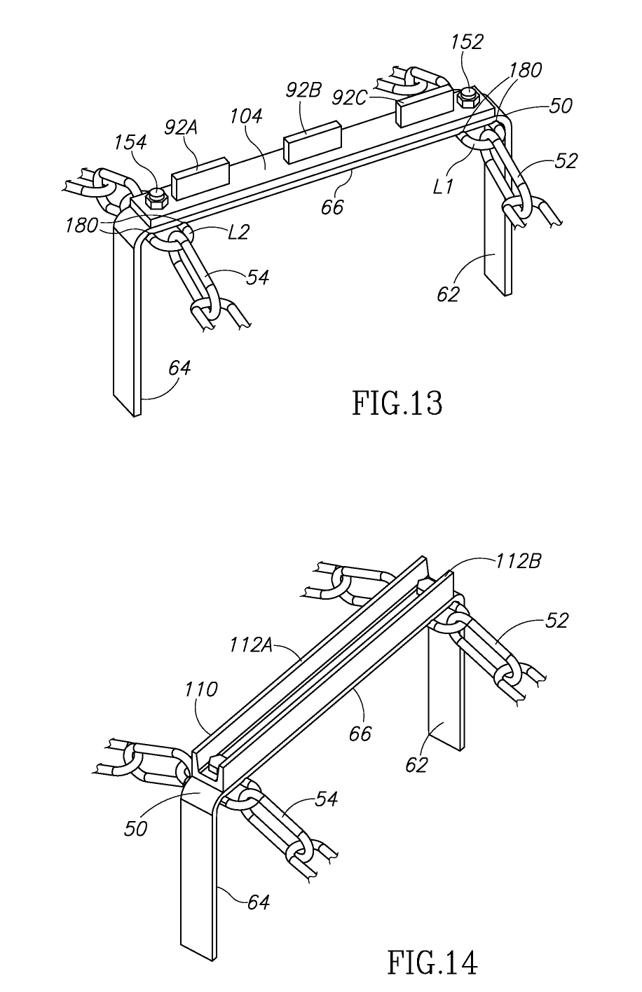

One or more traction structures (e.g., the cleat 90) are non-removably or permanently affixed to the second surface 104 of the grouser bar 100. Any of traction structures discussed above may be permanently affixed to the second surface 104 of the grouser bar 100. For example, referring to FIG. 13, the cleats 92A, 92B, and 92C may be permanently affixed to the second surface 104 of the grouser bar 100.

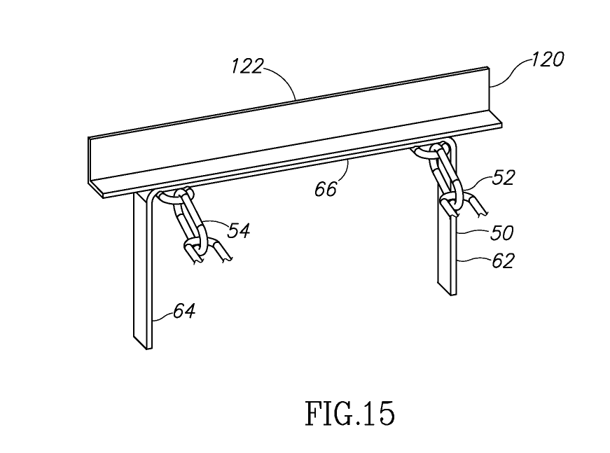

While the grouser bar 100 illustrated in FIGS. 11-13, 16, and 17 is substantially planar, this is not a requirement. For example, in the embodiment illustrated in FIG. 14, a substantially U-shaped or C-shaped grouser bar 110 is illustrated. In such an embodiment, the traction structures include spaced apart laterally extending cleats 112A and 112B. In the embodiment illustrated in FIG. 15, a substantially L-shaped grouser bar 120 is illustrated. In such an embodiment, the traction structures includes a single laterally extending cleat 122 positioned along one edge of the grouser bar 120. By way of a non-limiting example, the cleat 122 may extend upwardly about one inch. By way of further example, the L-shaped grouser bar 120 may extend laterally about 15 inches when configured for a 12 inch wide tire.

Returning to FIG. 11, the transverse portion 66 of each of the U-shaped members 50 may include a first through-hole 132 adjacent the first leg 62 and a second through-hole 134 adjacent the second leg 64. Each of the grouser bars 100 may include a first through-hole 142 configured to be aligned with the first through-hole 132 of the transverse portion 66 of one of the U-shaped members 50 and a second through-hole 144 configured to be aligned with the second through-hole 134 of the transverse portion 66 of the same one of the U-shaped member 50. When the first through-hole 142 of the grouser bar 100 is aligned with the first through-hole 132 of the transverse portion 66, a first fastener 152 (e.g., a bolt, a pin, and the like) may be used to removably couple the grouser bar 100 to the U-shaped member 50. Similarly, when the second through-hole 144 of a grouser bar 100 is aligned with the second through-hole 134 of the transverse portion 66, a second fastener 154 (e.g., a bolt, a pin, and the like) may be used to removably couple the grouser bar 100 to the U-shaped member 50. Thus, the first and second fasteners 152 and 154 may be used to couple each of the grouser bars 100 to the U-shaped members 50.

When the first and second fasteners 152 and 154 are implemented as bolts. It may be desirable to position a head 156 of the bolt adjacent the inwardly facing surface 72 (see FIG. 4) of the transverse portion 66 and to position a nut 158 adjacent the second surface 104 of the grouser bar 100 for easier access thereto to facilitate removal of the grouser bar from the U-shaped member 50.

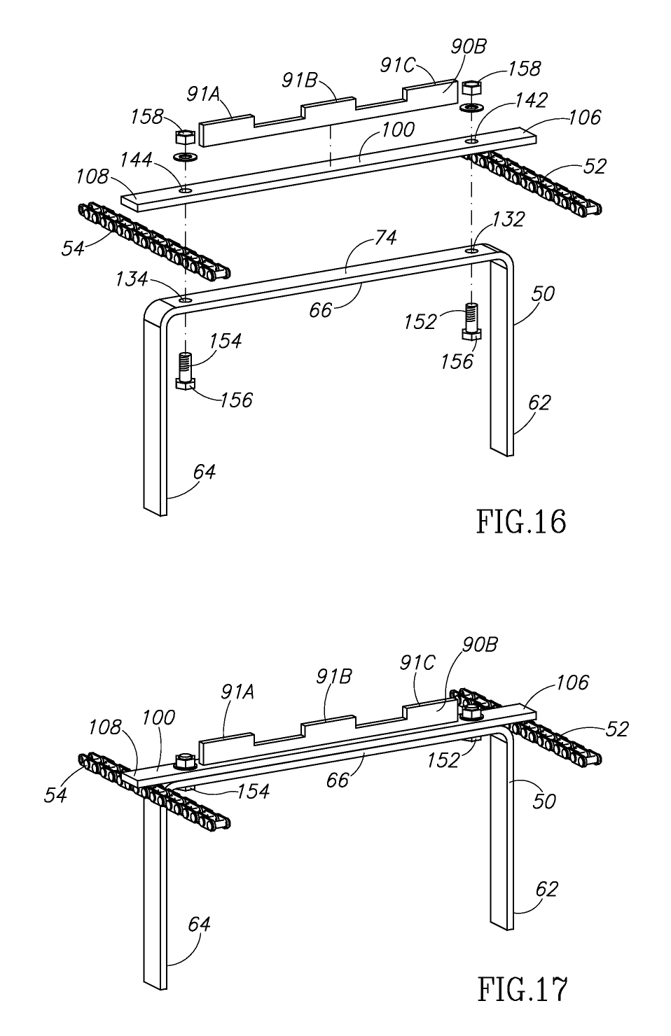

Referring to FIGS. 16 and 17, the grouser bars 100 may extend laterally beyond the first and second legs 62 and 64 of the U-shaped members 50. In the embodiment illustrated, the first end portion 106 of the grouser bar 100 extends laterally outwardly beyond the first leg 62 and the second end portion 108 of the grouser bar 100 extends laterally outwardly beyond the second leg 64. Similarly, as illustrated in FIG. 15, the L-shaped grouser bar 120 may extend laterally beyond the first and second legs 62 and 64 of the U-shaped members 50. While not illustrated, the grouser bar 110 illustrated in FIG. 14 may also extend laterally beyond the first and second legs 62 and 64 of the U-shaped members 50. As will be described below, portions of the grouser bars 100, 110, and 120 that extend laterally beyond the first and second legs 62 and 64 may be used as attachment points for the connecting segments 52 and 54. In embodiments in which the grouser bars 100, 110, and/or 120 extend laterally beyond the first and second legs 62 and 64 of the U-shaped members 50, the tire chain 10 (see FIGS. 1 and 3) may provide addition flotation and traction on soft ground.

Referring to FIGS. 16 and 17, the connecting segments 52 and 54 may be coupled (removably or non-removably) to the first and second end portions 106 and 108, respectively, of the grouser bars 100 instead of the U-shaped members 50. This arrangement may provide additional clearance for the more square or block-shaped tires. In such an embodiment, the connecting segments 52 and 54 and the grouser bars 100 may be replaced at the same time. In a similar manner, in alternate embodiments, the connecting segments 52 and 54 may be connected (removably or non-removably) to portions of the grouser bars 110 (see FIG. 14) and/or the grouser bars 120 (see FIG. 15) that extend laterally beyond the first and second legs 62 and 64.

Grouser bars 100, 110, and/or 120 may be selected and attached to the U-shaped members 50 based upon an amount of traction desired. In other words, the grouser bars 100, 110, and/or 120 may be used to customize the tire chain 10. For example, if the grouser bars 110 are attached to the U-shaped members 50 of the tire chain 10 but are unsuitable for user's traction needs, the user may replace the grouser bars 110 with the grouser bars 100 including the cleats 90 or other traction structures. Further, the user may replace only a portion of the grouser bars 110. Through the selection of grouser bars 100, 110, and/or 120 and traction structures, the user may assemble a customized version of the tire chain 10. In other words, the tire chain 10 is configurable and reconfigurable by the selection and removable attachment of the grouser bars 100, 110, and/or 120 to the U-shaped members 50, which are connected together by the connecting segments 52 and 54.

The grouser bars 100, 110, and/or 120 may be configured for use with many different types of terrain, surface conditions, and applications.

### Connecting Segments

In FIGS. 1-15, each of the connecting segments 52 and 54 is illustrated as a continuous section of a chain having conventional oval-shaped links. As may best be viewed in FIG. 3, in each of these embodiments, the connecting segment 52 has a first end portion 160 opposite a second end portion 162. Further, the connecting segment 54 has a first end portion 164 opposite a second end portion 166. The first and second end portions 160 and 162 of the connecting segment 52 are coupled together to form a continuous loop by a connector 172. Similarly, the first and second end portions 164 and 166 of the connecting segment 54 are coupled together to form a continuous loop by a connector 174. In the embodiment illustrated, the connectors 172 and 174 are implemented using conventional chain connectors (e.g., “add a link” connectors, quick link connectors, hooks, connecting links, carabiners, conventional tire chain connectors, and the like). Further, each of the connectors 172 and 174 may be shaped and sized to appear substantially similar to a link of the continuous sections of a chain. However, this is not a requirement.

In the embodiment illustrated, the connecting segment 52 is positioned alongside the side portion 42 of the outwardly facing surface 26 and the connecting segment 54 is positioned alongside the side portion 44 of the outwardly facing surface 26. When, as in FIGS. 1-15, the connecting segment 52 are implemented using sections of chain each having conventional oval-shaped links, the links of the connecting segment 52 may be substantially registered with the links of the connecting segment 54 across the outwardly facing surface 26. Each of the U-shaped members 50 may be non-removably affixed (e.g., welded) to a different selected link of the connecting segment 52 and a corresponding link of the chain segment 54 positioned across the outwardly facing surface 26 from the selected link of the connecting segment 52.

Alternatively, referring to FIG. 13, instead of permanently affixing a selected link “L1” of the connecting segment 52 and a corresponding link “L2” of the connecting segment 54 to the U-shaped members 50, the links “L1” and “L2” may be removably coupled to the U-shaped member 50 by the fasteners 152 and 154, respectively. In such an embodiment, the fasteners 152 and 154 are permanently affixed (e.g., welded) inside the links “L1” and “L2,” respectively. Optionally, the U-shaped member 50 may include one or more grooves 180 configured to receive the links “L1” and “L2.” The grooves 180 may be configured to help prevent rotation of the links “L1” and “L2” about the fasteners 152 and 154, respectively. In the embodiment illustrated in FIG. 13, the U-shaped member 50 may be removed from the connecting segments 52 and 54 by the user and the grouser bar 100 may be removed from the U-shaped member 50. Thus, the tire chain 10 (see FIG. 1) may be repaired and/or customized by removing one or more of the U-shaped member 50 and/or one or more of the grouser bars 100.

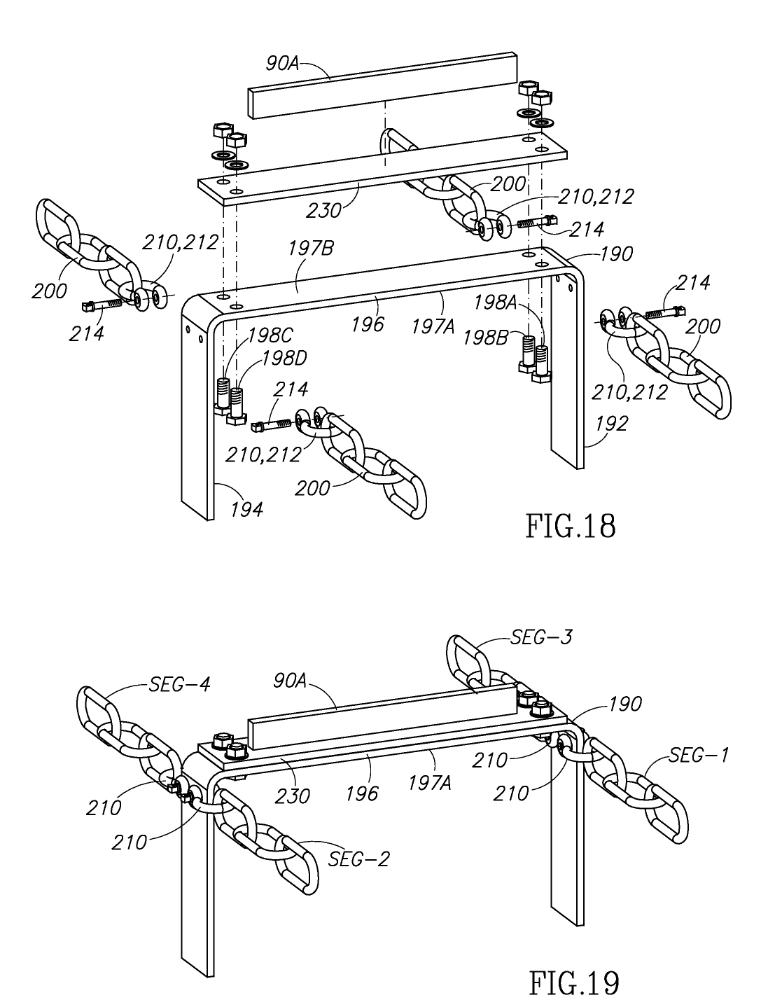

In an alternate embodiment illustrated in FIGS. 18 and 19, adjacent U-shaped members 190 are connected together by chain segments 200. In the embodiment illustrated, each of the chain segments 200 includes three conventional oval-shaped links. However, this is not a requirement.

The U-shaped members 190 are substantially similar to the U-shaped members 50 illustrated in FIGS. 1 and 3. However, the U-shaped members 190 may be wider than the U-shaped members 50. Referring to FIGS. 1 and 3, depending upon the implementation details, when the connecting segments 52 and 54 are each implemented using a segment of conventional chain constructed from a plurality of links, the width of the U-shaped members 50 may be constrained to being no wider than the links of the conventional chain. However, the U-shaped members 190 illustrated in FIGS. 18 and 19 are not subject to this constraint and may be constructed using any width desired.

Like the U-shaped members 50, the U-shaped members 190 each include a first leg 192, a second leg 194, and a transverse portion 196. The transverse portion 196 has an inwardly facing surface 197A (see FIG. 4) that faces the outwardly facing surface 26 (see FIGS. 1 and 3) of the tire 20 (see FIGS. 1 and 3) and an outwardly facing surface 197B opposite the inwardly facing surface 197A.

Four separate chain segments 200 are connected to each U-shaped members 190. Each of the four chain segments 200 is connected to the U-shaped member 190 by a connector 210. For ease of illustration, in FIG. 19, the chain segments 200 have been labeled “SEG-1,” “SEG-2,” “SEG-3,” and “SEG-4.” The chain segment “SEG-1” connects the first leg 192 of the U-shaped member 190 illustrated to a first leg (not shown) of an adjacent like U-shaped member (not shown). For example, the chain segment “SEG-1” may connect the first leg 192 of the U-shaped member 190 illustrated to the first leg (not shown) of a next U-shaped member (not shown) in the tire chain 10 (see FIG. 1). Similarly, the chain segment “SEG-2” may connect the second leg 194 of the U-shaped member 190 illustrated to a second leg (not shown) of the next U-shaped member (not shown) in the tire chain 10 (see FIG. 1). Continuing this example, the chain segment “SEG-3” may connect the first leg 192 of the U-shaped member 190 illustrated to a first leg (not shown) of a previous U-shaped member (not shown) in the tire chain 10 (see FIG. 1). Similarly, the chain segment “SEG-4” may connect the second leg 194 of the U-shaped member 190 illustrated to the second leg (not shown) of the previous U-shaped member (not shown) in the tire chain 10 (see FIG. 1). In this manner, the chain segments 200 may be used to connect the U-shaped members 190 together to form a continuous loop around the tire 20 (see FIG. 1).

Any of traction structures discussed above may be permanently affixed to the outwardly facing surface 197B of the U-shaped members 190. Alternatively, any of the grouser bars 100, 110, and 120 may be coupled to the U-shaped members 190. A wider grouser bar 230 may also be used with the U-shaped members 190. The grouser bar 230 may be removably coupled to the transverse portion 196 of the U-shaped member 190 by fasteners (e.g., fasteners 198A, 198B, 198C, and 198D) substantially similar to the fasteners 152 and 154 (see FIGS. 11 and 12). The fasteners 198A and 198B may be positioned adjacent the first leg 192 and the fasteners 198C and 198D may be positioned adjacent the second leg 194. Like the U-shaped members 50 (see FIGS. 1 and 3), the U-shaped members 190 are configured to function in a manner similar to that of a grouser. However, instead of being mounted on a track, the U-shaped members 190 are connected together by the chain segments 200.

Referring to FIG. 3, as is appreciated by those of ordinary skill in the art, some larger tires are more square or block-shaped, which provides less room for the connecting segments 52 and 54 between the U-shaped members 50 and the tire 20. The embodiment illustrated in FIGS. 18 and 19 may provide more clearance for square or block-shaped tires because the chain segments 200 are not positioned between the U-shaped members 190 and the tire 20 (see FIGS. 1 and 3).

The connectors 210 may be configured to pivot relative to the first and second legs 192 and 194 of the U-shaped member 190 as the tire 20 (see FIGS. 1 and 3) rotates. In the embodiment illustrated, the connectors 210 each include a clevis 212 coupled to the U-shaped member 190 by a transverse bolt 214. The clevises 212 may pivot about the transverse bolts 214 relative to the U-shaped member 190 as the tire 20 rotates.

While in FIGS. 1-15 the connecting segments 52 and 54 have each been illustrated as a section of a chain having conventional oval-shaped links, other structures may be used to implement the connecting segments 52 and 54. For example, in FIGS. 16 and 17, the connecting segments 52 and 54 have each been implemented using a section of roller chain. Roller chain restricts side-to-side (or lateral) movement of the tire chain 10 relative to the tire 20 thereby reducing the likelihood the tire chain 10 will slide off the tire 10 laterally. Roller chain also helps prevent twisting between the U-shaped members 50 thereby helping to maintain the U-shaped members 50 in proper alignment relative to the ground 28 and the tire 10. Roller chain may be bolted or welded to the U-shaped members 50 or the grouser bars 100, 110, and/or 120. The ends of the roller chain may be fastened together using a conventional master link.

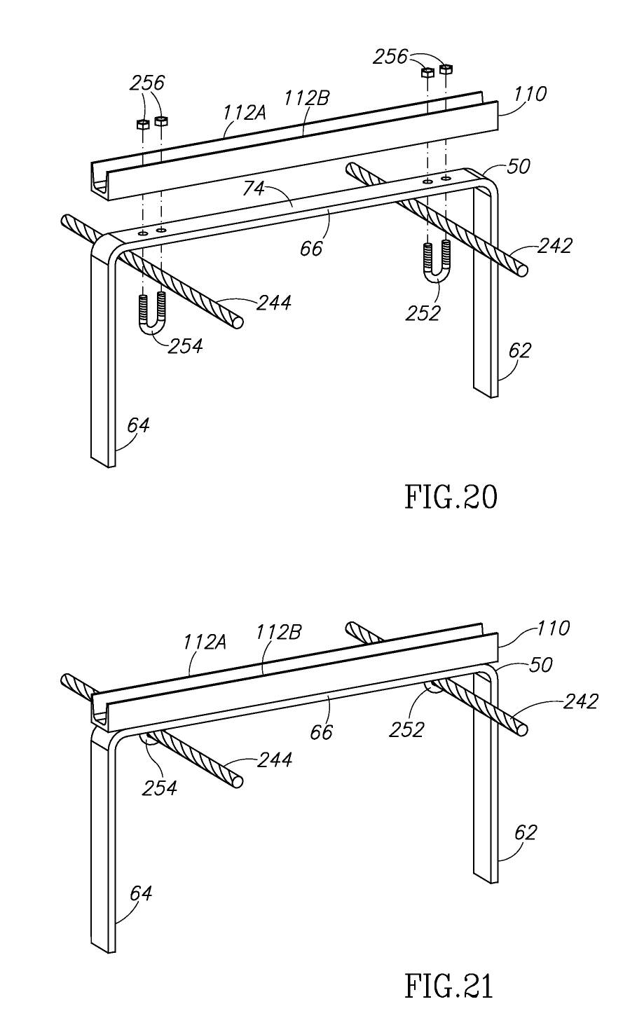

By way of another non-limiting example in FIGS. 20 and 21, the connecting segments 52 and 54 have been implemented using sections of cable 242 and 244, respectively. For example, cable having a diameter of about one quarter inch may be used to implement the sections of cable 242 and 244. The U-shaped member 50 are removably connected to the sections of cable 242 and 244 in a series to form the tire chain 10 (see FIGS. 1 and 3). The section of cable 242 is removably connected to each of the U-shaped members 50 by a connector 252 and the section of cable 244 is removably connected to each of the U-shaped members 50 by a connector 254. Thus, the tire chain 10 includes a plurality of connectors 252 and a plurality of connectors 254.

The connectors 252 and 254 may be configured to also removably couple a grouser bar (e.g., the grouser bar 110) to the U-shaped member 50. In the embodiment illustrated, the connectors 252 and 254 are each implemented as a threaded cable clamp inserted through through-holes formed in the U-shaped member 50 and through-holes (not shown) formed in the grouser bar 110 and held in place by nuts 256 (see FIG. 20).

The ends of each of the sections of cable 242 and 244 are fastened together to form a loop. By way of a non-limiting example, a first closed loop may be formed in one of the ends of the section of cable 242 and a second closed loop may be formed in the other end of the section of cable 242. The closed loops may be formed using any method known in the art. Then a connector (not shown) like the connector 172 (see FIG. 3) may be used to connect the first and second closed loops. Alternatively, a section of chain (not shown) may be connected to the first closed loop. In such an embodiment, a connector (not shown) like the connector 172 may be used to connect the section of chain (not shown) to the second closed loop. The section of chain (not shown) may be used to adjustment the tension in the cable. The ends of the section of cable 244 may be fastened together using any of the methods described above for fastening the ends of the section of cable 242 together.

By way of another non-limiting example, any conventional connecting members used to construct a conventional tire chain may be used to implement the connecting segments 52 and 54.

Through application of ordinary skill in the art to the present teachings, any of the structures described above as suitable for implementing the connecting segments 52 and 54 may be used to construct the chain segments 200 illustrated in FIGS. 18 and 19.

Further, while the connecting segments 52 and 54 and the chain segments 200 have been described as connecting the U-shaped members together or alternatively, connecting the grouser bars together, those of ordinary skill in the art appreciate that the connecting segments 52 and 54 or the chain segments 200 may connect a U-shaped member and a grouser bar together. Further, while the connecting segments 52 and 54 and the chain segments 200 have been described as connecting like structures together (e.g., the transverse portions 66 of the U-shaped members 50 together), those of ordinary skill in the art appreciate that the connecting segments 52 and 54 or the chain segments 200 may connect different structures together (e.g., the first leg 62 of one U-shaped member 50 may be connected to the transverse portion 66 of an adjacent U-shaped member 50 by the connecting segment 52).

Because only the planar inwardly facing surface 72 (see FIG. 4) of the U-shaped members 50 (see FIGS. 1 and 3) or the planar inwardly facing surface 197A (see FIGS. 18 and 19) of the U-shaped member 190 (see FIGS. 18 and 19) contacts the outwardly facing surface 26 (see FIGS. 1 and 3) of the tire 20 (see FIGS. 1 and 3), the tire chain 10 causes less wear to the tire than conventional tire chains that place chains and/or traction structures between the tire and the ground 28 (see FIG. 1).

Alternatively, portions of the connecting segments 52 and 54 or the chain segments 200 may be positioned adjacent to or along the outwardly facing surface 26 (see FIGS. 1 and 3) of the tire 20 (see FIGS. 1 and 3). In such embodiments, those portions of the connecting segments 52 and 54 or the chain segments 200 positioned adjacent to or along the outwardly facing surface 26 may be in contact the ground 28 as the tire 20 rotates to provide traction between the tire 20 and the ground 28.

Returning to FIG. 1, many of the components of the tire chain 10 are replaceable as well as interchangeable with the components of another tire chain like the tire chain 10. Therefore, the tire chain 10 may produce less waste and cost less than other tire chains currently available. Further, depending upon implementation details, the tire chain 10 may be installed on the tire 20 with a desired level of tension in the connecting segments 52 and 54 (or the chain segments 200) and during use, maintain that desired level of tension in the connecting segments 52 and 54 (or the chain segments 200).

Users do not have to stock or ship all the components of the tire chain 10, which may be quite heavy and therefore, expensive to ship. Instead, users can maintain a small inventory of the U-shaped members (e.g., the U-shaped members 50 and/or 190), a small inventory of the grouser bars (e.g., the grouser bars 100, 110, 120, and/or 230), and a small inventory of the connecting segments (e.g., the connecting segments 52 and 54 and/or the chain segments 200). Such users may replace the U-shaped members, grouser bars, and/or connecting segments as they wear out, instead of replacing the entire tire chain 10. This may reduce long-term maintenance costs associated with the tire chain 10.

The U-shaped members 50 and 190 and the grouser bars 100, 110, 120, and 230 may be constructed from steel. Further, the connecting segments 52 and 54 and the chain segments 200 may be implemented as steel chains.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A tire traction device for use with a rotatable tire having a first sidewall, a second sidewall, and an outer surface extending between the first and second sidewalls configured to engage a driving surface, the device comprising:
a plurality of spaced apart U-shaped members each comprising a first leg portion, a second leg portion spaced apart from the first leg portion, and a transverse portion extending between the first and second leg portions, each of the U-shaped members being configured to receive a portion of the tire between the first and second leg portions with the first leg portion positioned along the first sidewall, the second leg portion positioned along the second sidewall, and the transverse portion positioned along the outer surface of the tire configured to engage the driving surface, the first leg portion of each of the U-shaped members having a proximal end portion connected to the transverse portion and a distal end portion opposite the proximal end portion, the second leg portion of each of the U-shaped members having a proximal end portion connected to the transverse portion and a distal end portion opposite the proximal end portion, the distal end portions of the first leg portions of the U-shaped members being untethered from one another, the distal end portions of the second leg portions of the U-shaped members being untethered from one another, the transverse portion being substantially planar and having an outwardly facing surface and an inwardly facing surface positioned opposite the outwardly facing surface and adjacent the outer surface of the tire configured to engage the driving surface;
a plurality of grouser bars, each of the grouser bars being removably couplable to the outwardly facing surface of the transverse portion of a corresponding one of the U-shaped members; and
at least one traction structure for each grouser bar, each of the at least one traction structures being affixed to a corresponding one of the grouser bars;
a first connecting segment connecting the U-shaped members together in a series; and
a second connecting segment connecting the U-shaped members together in a series.

2. The device of claim 1, wherein the first connecting segment is coupled to the inwardly facing surface of the transverse portion of each of the U-shaped members between the first leg portion and the first sidewall of the tire, and
the second connecting segment is coupled to the inwardly facing surface of the transverse portion of each of the U-shaped members between the second leg portion and the second sidewall of the tire.

3. The device of claim 1, wherein the first connecting segment comprises a chain having a plurality of links and the second connecting segment comprises a chain having a plurality of links,
the links of the first connecting segment being registered with the links of the second connecting segment across the outer surface of the tire configured to engage the driving surface,
each of the U-shaped members being non-movably coupled to a different link of the chain of the first connecting segment and a different link of the chain of the second connecting segment with plural links of the chain of the first connecting segment being positioned between adjacent ones of the U-shaped members, and plural links of the chain of the second connecting segment being positioned between adjacent ones of the U-shaped members.

4. The device of claim 1, wherein the at least one traction structure for each grouser bar comprises an outwardly extending elongated cleat having a longitudinal dimension positioned to extend laterally relative to a direction of rotation of the tire.

5. The device of claim 4, wherein the cleat comprises an outer edge portion and a plurality of outwardly extending projections positioned along the outer edge portion.

6. The device of claim 1, wherein the at least one traction structure for each grouser bar comprises a plurality of spaced apart outwardly extending cleats or studs.

7. The device of claim 1, wherein the first and second connecting segments each comprise a first end and a second end,
the first end of the first connecting segment is connected to the second end of the first connecting segment by a first connector, and
the first end of the second connecting segment is connected to the second end of the second connecting segment by a second connector.

8. The device of claim 1, wherein the first and second connecting segments each comprise a link chain, a roller chain, or a cable.

9. The device of claim 1, wherein at least one of the grouser bars is removably couplable to the outwardly facing surface of the transverse portion of the corresponding U-shaped member by a first fastener positioned adjacent the first leg portion of the corresponding U-shaped member and a second fastener positioned adjacent the second leg portion of the corresponding U-shaped member.

10. The device of claim 1, wherein at least one of the grouser bars comprises a first end portion and a second end portion opposite the first end portion,
the first end portion extends laterally beyond the first leg portion of the corresponding U-shaped member to which the grouser bar is couplable, and
the second end portion extends laterally beyond the second leg portion of the corresponding U-shaped member to which the grouser bar is couplable.

11. The device of claim 10, wherein at least one of the grouser bars comprises a first surface and a second surface opposite the first surface,
the at least one traction structures are affixed to the first surfaces of the grouser bars;
the first connecting segment is coupled to the second surface at the first end portion of each of the grouser bars, and
the second connecting segment is coupled to the second surface at the second end portion of each of the grouser bars.

12. A customizable tire chain comprising:
a plurality of spaced apart U-shaped members each comprising a first leg portion, a second leg portion spaced apart from the first leg portion, and a transverse portion extending between the first and second leg portions, the transverse portion having an outwardly facing surface and a substantially planar inwardly facing surface positioned opposite the outwardly facing surface and adjacent the outer surface of the tire configured to engage the driving surface;
a plurality of grouser bars, each comprising a first side portion, and a second side portion opposite the first side portion, the first side portions of each of the grouser bars comprising a traction structure, the second side portions of each of the grouser bars being removably coupled to the transverse portion of a corresponding one of the U-shaped members;
a first connecting segment connecting the U-shaped members together in a series, the first connecting segment being coupled to the inwardly facing surfaces of the transverse portions of each of the U-shaped members at a location spaced apart from the outer surface of the tire configured to engage the driving surface; and
a second connecting segment connecting the U-shaped members together in the series, the second connecting segment being coupled to the inwardly facing surfaces of the transverse portions of each of the U-shaped members at a location spaced apart from the outer surface of the tire configured to engage the driving surface.

13. The customizable tire chain of claim 12, wherein the first side portions of a first portion of the grouser bars comprise traction structures different from those of the first side portions of a second portion of the grouser bars.

14. The customizable tire chain of claim 12, wherein at least a portion of the plurality of grouser bars are L-shaped,
the L-shaped grouser bars comprise an outwardly extending leg portion, and
the traction structures of the first side portions of the L-shaped grouser bars comprise the outwardly extending leg portion.

15. The customizable tire chain of claim 12, wherein at least a portion of the plurality of grouser bars are U-shaped,
the U-shaped grouser bars comprise a first outwardly extending leg portion spaced apart from a second outwardly extending leg portion, and
the traction structures of the first side portions of U-shaped grouser bars comprise the first and second outwardly extending leg portions.

16. A customizable tire chain comprising:
a plurality of spaced apart U-shaped members each comprising a first leg portion, a second leg portion spaced apart from the first leg portion, and a transverse portion extending between the first and second leg portions, the first leg portion and the second leg portion being positioned to receive an outer edge portion of a tire therebetween;
a plurality of grouser bars, each comprising a first side portion, a second side portion opposite the first side portion, a first end portion, and a second end portion opposite the first end portion, the first side portions of each of the grouser bars comprising a traction structure, the second side portions of each of the grouser bars being removably coupled to the transverse portion of a corresponding one of the U-shaped members, and when so coupled, the first end portion of the grouser bar extending laterally beyond the transverse portion of the corresponding one of the U-shaped members and the second end portion of the grouser bar extending laterally beyond the transverse portion of the corresponding one of the U-shaped members;
a first connecting segment connecting the grouser bars together in a series, the first connecting segment being coupled to the second side portions of each of the grouser bars at their first end portions; and
a second connecting segment connecting the grouser bars together in a series, the second connecting segment being coupled to the second side portions of each of the grouser bars at their second end portions.

17. A customizable tire chain for use with a tire having an outer edge portion, the tire chain comprising:
a plurality of spaced apart U-shaped members each comprising a first leg portion, a second leg portion spaced apart from the first leg portion, and a transverse portion extending between the first and second leg portions, the first leg portion and the second leg portion being positioned to receive the outer edge portion of the tire therebetween;
a plurality of grouser bars, each comprising a first side portion, and a second side portion opposite the first side portion, the first side portions of each of the grouser bars comprising a traction structure, the second side portions of each of the grouser bars being removably coupled to the transverse portion of a corresponding one of the U-shaped members; and
a plurality of connecting segments connecting either the U-shaped members or the grouser bars together in a series, the connecting segments being spaced apart from the outer edge portion of the tire to avoid contact therewith.

18. A customizable tire chain for use with a tire having an outer edge portion, the tire chain comprising:
a plurality of spaced apart U-shaped members each comprising a first leg portion, a second leg portion spaced apart from the first leg portion, and a transverse portion extending between the first and second leg portions, the first leg portion and the second leg portion being positioned to receive the outer edge portion of the tire therebetween;
a plurality of grouser bars, each comprising a first side portion, and a second side portion opposite the first side portion, the first side portions of each of the grouser bars comprising a traction structure, the second side portions of each of the grouser bars being removably coupled to the transverse portion of a corresponding one of the U-shaped members;
a first plurality of connecting segments connecting the first leg portions of the U-shaped members together in a series; and
a second plurality of connecting segments connecting the second leg portions of the U-shaped members together in a series.

19. A vehicle comprising:
a rotatable tire having a first sidewall, a second sidewall, and an outer surface extending between the first and second sidewalls configured to engage a driving surface;
a tire traction device entwined about the rotatable tire for rotation therewith, the tire traction device comprising:
a plurality of spaced apart U-shaped members each comprising a first leg portion, a second leg portion spaced apart from the first leg portion, and a transverse portion extending between the first and second leg portions, each of the U-shaped members being configured to receive a portion of the tire between the first and second leg portions with the first leg portion being positioned along the first sidewall, the second leg portion being positioned along the second sidewall, and the transverse portion being positioned along the outer surface of the tire configured to engage the driving surface, the first leg portion of each of the U-shaped members having a proximal end portion connected to the transverse portion and a distal end portion opposite the proximal end portion, the second leg portion of each of the U-shaped members having a proximal end portion connected to the transverse portion and a distal end portion opposite the proximal end portion, the distal end portions of the first leg portions of the U-shaped members being untethered from one another, the distal end portions of the second leg portions of the U-shaped members being untethered from one another, the transverse portion having an outwardly facing surface and a substantially planar inwardly facing surface positioned opposite the outwardly facing surface and adjacent the outer surface of the tire configured to engage the driving surface;
a plurality of grouser bars, each comprising a first side portion, and a second side portion opposite the first side portion, the first side portions of each of the grouser bars comprising a traction structure, the second side portions of each of the grouser bars being removably coupled to the outwardly facing surface of the transverse portion of a corresponding one of the U-shaped members; and
a plurality of connecting segments connecting the U-shaped members together in a series.
